(19) United States
(12) Patent Application Publication
(10) Pub. No.: US 2019/0220889 A1
(43) Pub. Date: Jul. 18, 2019

(54) INFORMATION SENDING METHOD, APPARATUS, AND SYSTEM

(71) Applicant: TENCENT TECHNOLOGY (SHENZHEN) COMPANY LIMITED, Shenzhen (CN)

(72) Inventors: Hongyu WEI, Shenzhen (CN); Zhe FENG, Shenzhen (CN); Qiyun SU, Shenzhen (CN); Xuekai LI, Shenzhen (CN); Yi JIANG, Shenzhen (CN); Yanmin WANG, Shenzhen (CN); Lingling YAO, Shenzhen (CN); Yan ZHAO, Shenzhen (CN); Lei HUANG, Shenzhen (CN)

(21) Appl. No.: 16/363,180

(22) Filed: Mar. 25, 2019

Related U.S. Application Data
(63) Continuation of application No. PCT/CN2017/117999, filed on Dec. 22, 2017.

(30) Foreign Application Priority Data
Dec. 23, 2016 (CN) 201611208591.7

(51) Int. Cl. G06Q 30/02

(52) U.S. Cl. CPC G06Q 30/0245; G06F 16/953; G06Q 30/0255

(57) ABSTRACT

An information sending method, an apparatus, and a system are provided. The method includes receiving, by a server, an information obtaining request sent by a terminal, the information obtaining request carrying a user identifier; and querying, by the server according to the information obtaining request, historical information corresponding to the user identifier. The method also includes obtaining, by the server, negative feedback information corresponding to the user identifier and associated with the historical information, the negative feedback information comprising a negative feedback reason; and determining, by the server, an information adjustment manner according to the negative feedback reason in the negative feedback information. The method also includes: adjusting, according to the information adjustment manner, an information queue corresponding to the user identifier; and sending, by the server, corresponding information to the terminal according to the adjusted information queue.

### RELATED APPLICATIONS

This application is a continuation application of PCT Patent Application No. PCT/CN2017/117999, filed on Dec. 22, 2017, which claims priority to Chinese Patent Application No. 201611208591.7, filed with the Chinese Patent Office on Dec. 23, 2016 and entitled “ADVERTISEMENT INFORMATION SENDING METHOD, APPARATUS, AND SYSTEM”, the entire contents of both of which are incorporated herein by reference.

### FIELD OF TECHNOLOGY

This application relates to the field of communications technologies, and specifically, to an information sending method, an apparatus, and a system.

### BACKGROUND OF THE DISCLOSURE

Currently, different types of information, for example, advertisement information, multimedia information, product information, resource information, and particular presentation information, are currently usually pushed to a user terminal in a fixed sequence.

Using the advertisement information as an example, advertisement is an important method to realize a social network product, and user experience to the advertisement directly affects the stickiness of a user to a social product. In the social product, the advertisement is usually presented as a picture material, and the quality of the material and the accuracy of personalization of content become a new focus of the user experience.

Currently, in an advertisement advertising manner of the social network, generally, fixed advertisement information is first configured for a user, and the advertisement information is pushed to the user terminal in a fixed sequence. This may result that advertisement information not suitable for the user has a relatively high presentation rate, and advertisement information suitable for the user has a relatively low presentation rate, causing relatively low accuracy and flexibility of advertising of the advertisement information.

### SUMMARY

Embodiments of this application provide an information sending method, an apparatus, and a system, to improve the accuracy and flexibility of information advertising.

One aspect of the present disclosure provides an information sending method. The method includes receiving, by a server, an information obtaining request sent by a terminal, the information obtaining request carrying a user identifier; and querying, by the server according to the information obtaining request, historical information corresponding to the user identifier. The method also includes obtaining, by the server, negative feedback information corresponding to the user identifier and associated with the historical information, the negative feedback information comprising a negative feedback reason; and determining, by the server, an information adjustment manner according to the negative feedback reason in the negative feedback information. The method also includes adjusting, according to the information adjustment manner, an information queue corresponding to the user identifier; and sending, by the server, corresponding information to the terminal according to the adjusted information queue.

Another aspect of the present disclosure provides an information sending apparatus, including a processor and a memory connected to the processor, the memory storing an instruction unit capable of being executed by the processor. The processor is configured to: receive an information obtaining request sent by a terminal, the information obtaining request carrying a user identifier; and query, according to the information obtaining request, historical information corresponding to the user identifier. The processor is also configured to: obtain negative feedback information corresponding to the user identifier and associated with the historical information, the negative feedback information comprising a negative feedback reason; and determine an information adjustment manner according to the negative feedback reason in the negative feedback information. The processor is also configured to: adjust, according to the information adjustment manner, an information queue corresponding to the user identifier; and send corresponding information to the terminal according to the adjusted information queue.

Another aspect of the present disclosure provides a non-transitory storage medium storing a computer program. The computer program, when being executed by a processor, cause the processor to perform: receiving an information obtaining request sent by a terminal, the information obtaining request carrying a user identifier; and querying, according to the information obtaining request, historical information corresponding to the user identifier. The computer program also cause the processor to perform: obtaining, negative feedback information corresponding to the user identifier and associated with the historical information, the negative feedback information comprising a negative feedback reason; and determining an information adjustment manner according to the negative feedback reason in the negative feedback information. The computer program also cause the processor to perform adjusting, according to the information adjustment manner, an information queue corresponding to the user identifier; and sending corresponding information to the terminal according to the adjusted information queue.

In addition, an embodiment of the present disclosure further provides an information sending system, including any information sending apparatus according to the embodiments of the present disclosure.

In the embodiments of this application, an information obtaining request sent by a terminal is received, the information obtaining request carrying a user identifier; then, historical information corresponding to the user identifier is queried according to the information obtaining request; negative feedback information corresponding to the user identifier and associated with the historical information is obtained; a corresponding information adjustment manner according to a negative feedback reason in the negative feedback information is determined; an information queue corresponding to the user identifier is adjusted according to the information adjustment manner; and corresponding information is sent to the terminal according to the adjusted information queue. According to this solution, to-be-sent information queue can be dynamically adjusted according to the negative feedback information of the user for the historical information, and a presentation rate of information suitable for the user is increased. Therefore, according to this solution, the accuracy and flexibility of information presentation/advertising can be improved.

### BRIEF DESCRIPTION OF THE DRAWINGS

To describe the technical solutions of the embodiments of this application more clearly, the following briefly introduces the accompanying drawings required for describing the embodiments. Apparently, the accompanying drawings in the following description show only some embodiments of this application, and a person of ordinary skill in the art may still derive other drawings from these accompanying drawings without creative efforts.

FIG. 1a is a schematic diagram of a scenario of an information sending system according to an embodiment of this application;

FIG. 1b is a flowchart of an information sending method according to an embodiment of this application;

FIG. 1c is a schematic diagram of adjusting an information queue according to an embodiment of this application;

FIG. 2a is another flowchart of an information sending method according to an embodiment of this application;

FIG. 2b is a schematic diagram of a negative feedback of advertisement according to an embodiment of this application;

FIG. 2c is a schematic diagram of a negative feedback reason according to an embodiment of this application;

FIG. 2d is another schematic diagram of a negative feedback reason according to an embodiment of this application;

FIG. 2e is another schematic diagram of adjusting an information queue according to an embodiment of this application;

FIG. 3a is a schematic structural diagram of an information sending apparatus according to an embodiment of this application;

FIG. 3b is another schematic structural diagram of an information sending apparatus according to an embodiment of this application;

FIG. 3c is still another schematic structural diagram of an information sending apparatus according to an embodiment of this application; and

FIG. 3d is still another schematic structural diagram of an information sending apparatus according to an embodiment of this application.

### DESCRIPTION OF EMBODIMENTS

In embodiments of this application, to improve the accuracy and flexibility of information advertising, it is considered that after an information obtaining request of a terminal is received, corresponding historical information is queried according to a user identifier in the information obtaining request, and negative feedback information corresponding to the user identifier and associated with the historical information is obtained, so that a corresponding information adjustment manner can be determined according to a negative feedback reason in the negative feedback information, a to-be-sent information queue is dynamically adjusted according to the information adjustment manner, and corresponding information is sent to the terminal according to the adjusted information queue, to increase a presentation rate of information suitable for the user, and increase the accuracy and flexibility of information advertising.

The following clearly and completely describes the technical solutions in the embodiments of this application with reference to the accompanying drawings in the embodiments of this application. Apparently, the described embodiments are some embodiments of this application rather than all of the embodiments. All other embodiments obtained by a person skilled in the art based on the embodiments of this application without creative efforts shall fall within the protection scope of this application.

An embodiment of this application provides an information sending method, an apparatus, and a system.

The information sending system may include any information sending apparatus provided in the embodiments of this application. The information sending apparatus may be specifically integrated into a network device such as a server. In addition, the information sending system may further include another device, for example, a device such as a terminal.

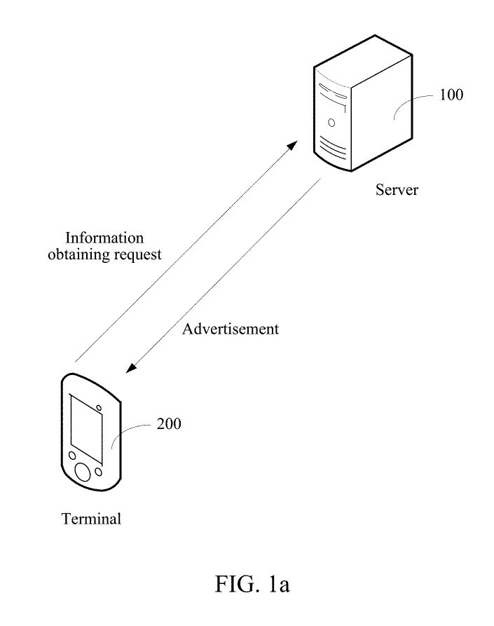

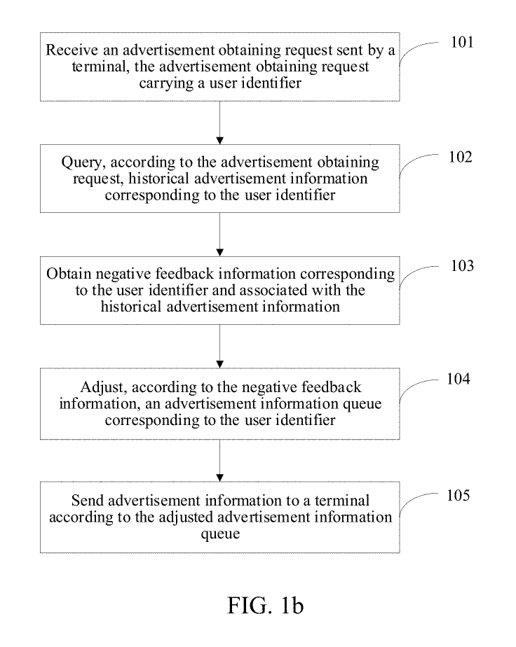

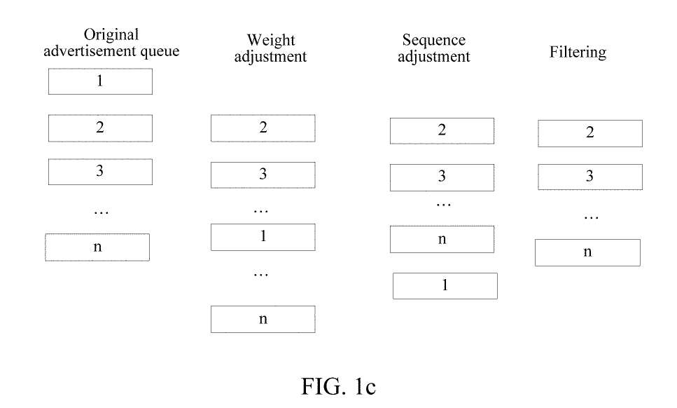

FIG. 1a is a schematic diagram of a scenario of an information sending system according to an embodiment of this application. As shown in FIG. 1a, the information sending system may include: a server 100 and a terminal 200. The server 100 integrates any information sending apparatus according to the embodiments of this application. The service 100 and the terminal 200 may be connected by using a network. The server 100 may be a separate physical server or a physical server cluster. The terminal 200 may be a device such as a personal computer, a handheld or laptop device, and a mobile device (for example, a mobile phone, a personal digital assistant (PDA), and a media player).

When a piece of information (e.g., an advertisement) needs to be presented, the terminal 200 may send an information obtaining request to the server 100, the information obtaining request carrying a user identifier, then, the server 100 queries, according to the information obtaining request, historical information corresponding to the user identifier, obtains negative feedback information that is of the user corresponding to the user identifier and that is for the historical information, adjusts, according to the negative feedback information, an information queue corresponding to the user identifier, and sends corresponding information to the terminal 200 according to the adjusted information queue. After receiving the information, the terminal 200 may present the information. As used herein, advertisement information is used as an example in embodiments of the present disclosure for illustrative purposes. However, other types of information can also be processed and presented to the user terminal based on user feedback by implementing the disclosed embodiments. For example, a queue of articles in a forum or a news website can be adjusted based on feedback provided by the user on historical (i.e., previously presented) articles, and a target article can be presented to a reader according to the adjusted queue. Similarly, post/tweet information in a social networking website can be rearranged and selected before presenting to the user based on previous feedback. In another example, a video or music hosting website/application can rearrange a queue of videos or music pieces to be presented to the user based on user feedback on previously listened/watched media.

The negative feedback information may include information fed back when the user closes, hides, or reports the historical information. For example, the negative feedback information is information fed back by the user by using a closing entrance of the historical information (e.g., when a user selects to stop a presentation of an information piece, such as close/skip an advertisement, close a video playback window, switch to a next song/video, etc., a feedback collection interface is presented on the user terminal. The feedback collection interface may list multiple options/reasons for a user to choose from, one or more options selected by the user is recorded as negative feedback information associated with the information piece). The historical information may include one or more pieces of previously presented information that has feedback recorded. The negative feedback information may include information about a negative feedback reason, and the like. In this case, the server 110 may determine a corresponding information adjustment manner according to the negative feedback reason, obtain attribute information corresponding to the historical information, and adjust, according to the advertisement information adjustment manner and the attribute information, the information queue corresponding to the user identifier.

In addition, the negative feedback information may further include a negative feedback rate corresponding to the historical information in a preset time period (or referred to as an information negative feedback rate), that is, a ratio of the number of negative feedback (for example, skip, close, hide, or report) times of the historical information in the preset time period by each user to the total number of presentation times of the historical information. In this case, when the negative feedback rate is greater than a preset threshold, the server 110 may obtain industry type information corresponding to the historical information, and block, according to the industry type information, corresponding information in the information queue corresponding to the user identifier. In some embodiments, each piece of historical information may correspond to one negative feedback rate. When there are multiple pieces of historical information with negative feedback rates that are greater than the preset threshold, the server may, for each of the multiple pieces of the historical information, obtain industry type corresponding to the one piece, and block information having the same industry type as the piece of historical information respectively.

The information sending method, the apparatus, and the system are respectively described in detail below by using a case in which the information is advertisement information and the information obtaining request is an advertisement obtaining request as an example.

FIG. 1b is a flowchart of an information sending method according to an embodiment of this application. In this embodiment, a description is provided from the perspective of an advertisement information sending apparatus, and the advertisement information sending apparatus may be integrated into a network device such as a server 110.

An advertisement information sending method is disclosed. An advertisement obtaining request sent by a terminal is received, the advertisement obtaining request carrying a user identifier, then, historical advertisement information corresponding to the user identifier is queried according to the advertisement obtaining request, negative feedback information corresponding to the user identifier and associated with the historical advertisement information (e.g., negative feedback, such as a negative feedback reason, provided by a user about a previously-shown advertisement piece) is obtained, an advertisement information queue corresponding to the user identifier is adjusted according to the negative feedback information; and corresponding advertisement information is sent to the terminal according to the adjusted advertisement information queue.

As shown in FIG. 1b, a specific procedure of the information sending method may be as follows:

Step 101. Receive an advertisement obtaining request sent by a terminal, the advertisement obtaining request carrying a user identifier.

The user identifier may be a character used to identify a user identity in a network. For example, the user identifier may be a social network account, an instant messaging account, and the like.

Step 102. Query, according to the advertisement obtaining request, historical advertisement information corresponding to the user identifier.

The historical advertisement information is advertisement information already sent to the user identifier previously.

Specifically, a historical advertisement recording file corresponding to the user identifier may be obtained according to the advertisement obtaining request, and then, the historical advertisement recording file is queried for the historical advertisement information. The historical advertisement recording file includes the advertisement information or an identifier of the advertisement information already sent to the user identifier previously.

Step 103. Obtain negative feedback information corresponding to the user identifier and associated with the historical advertisement information.

The negative feedback information may include information fed back when the user corresponding to the user identifier closes, hides, or reports the historical advertisement information. For example, the negative feedback information is information fed back when the user corresponding to the user identifier closes the historical advertisement information by using a closing entrance of the historical advertisement information. The negative feedback information may include information about a negative feedback reason.

The negative feedback reason may be set according to an actual requirement, and negative feedback reasons set by social platforms may be different. For example, advertisement inventory compositions and user group compositions of different traffic are different, and therefore, settings of the negative feedback reason are also different.

For example, in some embodiments, the negative feedback reason may include: frequently appeared, dislike the content, unrelated, already purchased, sham advertisement, and the like. In some other embodiments, the negative feedback reason may include: hiding this advertisement, reducing such advertisement, and the like.

Generally, after receiving the negative feedback information of the user, a network side device stores the negative feedback information, and therefore, the negative feedback information corresponding to the historical advertisement information may be obtained from a negative feedback information storage unit. For example, the negative feedback information may be obtained from the local negative feedback information local storage unit. For another example, when the negative feedback information storage unit is located in another network device, the negative feedback information may be obtained from the another network device.

In this embodiment, the negative feedback information corresponding to the historical advertisement information may be obtained according to an information identifier of the historical advertisement information. For example, the negative feedback information corresponding to the historical advertisement information may be obtained from the local storage unit according to the information identifier of the historical advertisement information.

Step 104. Adjust, according to the negative feedback information, an advertisement information queue corresponding to the user identifier.

The advertisement information queue corresponding to the user identifier may include all advertisement information in an advertisement library, or include advertisement information selected from the advertisement library by using a preset selection rule.

The adjusting the advertisement information queue means adjusting a sorting sequence of the advertisement information in the advertisement information queue, that is, adjusting positions of the advertisement information in the advertisement information queue.

The advertisement information queue includes at least one piece of to-be-sent advertisement information, and the advertisement information is sorted in the advertisement queue according to a particular sequence.

Specifically, to improve the adjustment flexibility and variety of the advertisement information, and further improve the accuracy of advertising of the advertisement information, in this implementation, the advertisement information queue may be adjusted by using different adjustment manners based on different negative feedback information. That is, the step of “adjusting, according to the negative feedback information, an advertisement information queue corresponding to the user identifier” may include:

determining a corresponding advertisement information adjustment manner according to the negative feedback information; and

adjusting the advertisement information queue corresponding to the user identifier according to the advertisement information adjustment manner.

In this embodiment, various advertisement information adjustment manners (referred to as candidate advertisement information adjustment manners) may be preset. In this way, after the negative feedback information is obtained, a corresponding advertisement information adjustment manner may be determined in the various advertisement information adjustment manners according to the negative feedback information. That is, the step of “determining a corresponding advertisement information adjustment manner according to the negative feedback information” may include: determining the corresponding advertisement information adjustment manner from the candidate advertisement information adjustment manners according to the negative feedback information.

In an actual application, when the negative feedback information includes the negative feedback reason, the advertisement information queue may be adjusted by using different advertisement information adjustment manners based on different negative feedback reasons. That is, the step of “determining a corresponding advertisement information adjustment manner according to the negative feedback information” may include: determining the corresponding advertisement information adjustment manner according to the negative feedback reason. For example, the corresponding advertisement information adjustment manner may be determined, based on the negative feedback reason, in various candidate advertisement information adjustment manners.

Specifically, the negative feedback reason of the advertisement may be classified to obtain a plurality of reason types. For example, based on emotion or perception to the advertisement, the negative feedback reason may be classified into an advertisement type fed up by a user and an advertisement type not fed up by a user, or the negative feedback reason is classified into an advertisement hidden type and an advertisement deleted type. In this case, in this embodiment, a reason type to which the negative feedback reason belongs may be determined first, and then, an advertisement information adjustment manner corresponding to the reason type may be obtained. That is, the step of “determining the corresponding advertisement information adjustment manner according to the negative feedback reason” may include: determining the reason type to which the negative feedback reason belongs, and obtaining an advertisement information adjustment manner corresponding to the reason type. In an actual application, the negative feedback reason may be classified according to an actual requirement, to obtain different reason types.

For example, when the negative feedback reason is “dislike the content”, it may be determined that the reason type to which the reason belongs is the advertisement type fed up by the user. In this case, the advertisement information adjustment manner corresponding to the advertisement type fed up by the user is: performing filtering, for example, removing or deleting, on the advertisement queue. For another example, when the negative feedback reason is hiding the advertisement, it may be determined that the reason type to which the reason belongs is the advertisement hidden type, and in this case, the obtained advertisement information adjustment manner corresponding to the reason type may be that: re-sorting the advertisement in the advertisement queue.

For example, in this embodiment, a set of reasons may be preset. After the negative feedback reason is obtained, the negative feedback reason may be matched with a sample reason in the set of reasons, and then, an advertisement information adjustment manner corresponding to the matched sample reason is obtained.

For example, the preset set of reasons includes: a negative feedback reason 1, a negative feedback reason 2, . . . , a negative feedback reason n, and when the negative feedback reason is the negative feedback reason 2, a preset advertisement information adjustment manner D corresponding to the negative feedback reason 2 may be obtained.

In this embodiment, there is a plurality of advertisement information adjustment manners, which may be specifically set according to an actual requirement. For example, the advertisement information adjustment manner may include: adjusting the positions of the advertisement information in the advertisement information queue, that is, sorting the advertisement information in the advertisement information queue. For example, advertisement information ranking first in the queue may be adjusted to the tail of the queue, or all advertisement information in the queue is re-sorted. The advertisement information adjustment manner may further include filtering (removing or deleting) the advertisement information in the queue. For example, advertisement information is removed or deleted from the queue. For example, advertisement information a in the queue is removed from the queue. In addition, the advertisement information adjustment manner may further include adjusting content of the advertisement information in the queue, for example, removing a word, a picture, a watermark, and the like unrelated to a product from the content of the advertisement; and adjusting the information size of the advertisement information in the queue, for example, compressing the advertisement information. For example, the advertisement information may be compressed from 10 kb to 8 kb. Formats of the advertisement information in the queue may be adjusted. For example, when the advertisement information is a picture, picture format of the advertisement information may be adjusted.

In this embodiment, when the advertisement information queue is adjusted, corresponding advertisement information may be adjusted based on attribute information of the historical advertisement information. That is, the step of “adjusting the advertisement information queue corresponding to the user identifier according to the advertisement information adjustment manner” may include:

obtaining attribute information corresponding to the historical advertisement information; and

adjusting the advertisement information queue corresponding to the user identifier according to the advertisement information adjustment manner and the attribute information.

The attribute information of the advertisement information may be obtained by classifying or defining the advertisement information from different perspectives. For example, the attribute information of the advertisement information may include at least one of: an identifier of the advertisement information, advertisement category information corresponding to the advertisement information, commodity information of commodities to which the advertisement information belongs (information such as commodity names, prices, and commodity manufacturers), and industry information corresponding to the advertisement information (such as dating-type advertisement, cloth advertisement, and financial advertisement). In an actual application, one commodity may correspond to a plurality of pieces of advertisement, and one piece of advertisement only belongs to one commodity.

In this embodiment, the advertisement queue may be adjusted from different dimensions such as the advertisement identifier, the advertisement category, and the advertisement commodity. For example, when the attribute information includes an advertisement category to which the historical advertisement information belongs, the advertisement information in the advertisement information queue belonging to the category may be adjusted, that is, advertisement information that belongs to a category the same as the historical advertisement information is adjusted. For example, the historical advertisement information is shoe advertisement information, and then the shoe advertisement information in the queue may be adjusted. For another example, when the attribute information includes a commodity to which the historical advertisement information belongs, the advertisement information in the advertisement information queue belonging to the commodity may be adjusted, that is, advertisement information that belongs to a commodity the same as the historical advertisement information is adjusted. For example, the historical advertisement information is cloth advertisement information, and then the cloth advertisement information in the queue may be adjusted. For another example, when the attribute information includes the advertisement identifier (ID) of the historical advertisement information, advertisement information having a same ID as the historical advertisement information in the advertisement information queue may be adjusted. For example, the historical advertisement information is advertisement a of a hat A. If the advertisement a exists in the queue, the advertisement a may be deleted from the queue.

Various attribute information described above such as the identifier, the category, and the commodity may be combined with each other. In this case, the adjustment object in the advertisement information queue may also be combined with each other. For example, when the attribute information includes the commodity and the category, advertisement information, in the queue, of same products and same categories may be adjusted.

Adjustment of the advertisement information queue based on the attribute information in different advertisement information adjustment manners is specifically described as follows:

(1) Advertisement Sorting:

Positions of the advertisement information in the advertisement information queue are adjusted (that is, advertisement sorting), and in this case, the step of “adjusting the advertisement information queue corresponding to the user identifier according to the advertisement information adjustment manner and the attribute information” may include:

determining, according to the attribute information, corresponding target advertisement information in the advertisement information queue corresponding to the user identifier; and

adjusting a position of the target advertisement information in the advertisement information queue.

For example, advertisement information that belongs to a same product and/or a same advertisement category as the historical advertisement information does in the advertisement information queue is determined, and then, a position of the determined advertisement information in the queue is adjusted.

There is a plurality of position adjustment manners of the advertisement information in the queue, which may be as follows:

(1-1). Target advertisement information may be directly adjusted to a preset position of the advertisement information queue, which may be referred to as sequence adjustment. The preset position may be set according to an actual requirement, for example, the tail of the queue.

For example, the advertisement information that belongs to a same product and/or category the same as the historical advertisement information does is adjusted to the tail of the advertisement information queue. Referring to FIG. 1c, for example, advertisement 1 is used as target advertisement information. In sequence adjustment, the advertisement 1 may be adjusted to the tail of the queue.

(1-2). A sorting parameter of the advertisement may be set, and then, the advertisement is sorted based on the sorting parameter.

Specifically, the step of adjusting a position of the target advertisement information in the advertisement information queue may include:

configuring a sorting parameter value corresponding to the target advertisement information; and

sorting positions of the advertisement information in the advertisement information queue according to sorting parameter values corresponding to the advertisement information in the advertisement information queue.

For example, the sorting parameter value corresponding to the target advertisement information is multiplied with a weight, and then, sorting is performed according to a sorting parameter value of each piece of advertisement information. This manner may be referred to as weight adjustment. The weight may be set according to an actual requirement, and may be set according to attribute information of the target advertisement information.

The sorting parameter may include: a pCtr (Predict CTR, advertisement hit rate prediction), an eCPM (Effective CPM, effective exposed price), other parameters used to indicate advertisement sorting, or the like.

For example, a pCtr of advertisement information that belongs to a commodity and/or category the same as the historical advertisement information in the advertisement information queue does is multiplied with a weight, and then, sorting is performed according to pCtr of each piece of advertisement information.

Referring to FIG. 1c, FIG. 1c is a schematic diagram of adjustment of an information queue according to an embodiment of this application. For example, advertisement 1 is target advertisement information. After weight adjustment, the advertisement 1 may be adjusted from a head position of the queue to a middle position of the queue.

(2) Advertisement Filtering:

That is, the advertisement information is removed from the advertisement information queue. In this case, the step of “adjusting an advertisement information queue corresponding to the user identifier” may include:

determining, according to the attribute information, corresponding target advertisement information in the advertisement information queue corresponding to the user identifier; and

removing the target advertisement information from the advertisement information queue.

For example, the advertisement information that belongs to a commodity and/or category the same as the historical advertisement information does is removed from the queue.

Referring to FIG. 1c, for example, advertisement 1 is target advertisement information. The advertisement 1 may be directly removed from the queue.

The weight adjustment manner may be relatively flexible. However, consequently, the queue may be maintained unchanged. The sequence adjustment manner avoids all disadvantages of the weight adjustment manner, and affects more greatly on the overall traffic cash conversion efficiency. An advertisement filtering manner can avoid disadvantages of the weight adjustment manner and the sequence adjustment manner, and is more effective.

Considering that user requirements or preferences vary all the time, if absolute adjustment is performed (that is, the queue is adjusted in any time period of a request advertisement), some advertisement information having negative feedbacks or advertisement information related to negative feedback advertisement may not be displayed for a long time, or have a relatively low presentation rate in a long period of time. This reduces the accuracy and the flexibility of advertising of the advertisement information. To overcome the foregoing problem, in this embodiment, an adjustment time period may be set for each advertisement information adjustment manner, and the queue is adjusted only in the corresponding adjustment time period. That is, different processing phases may be designed in a time dimension. That is, after the determining a corresponding information adjustment manner according to the negative feedback reason, and before the obtaining the attribute information, the embodiment method may further include:

obtaining a current system time;

determining whether the system time falls within a preset time period corresponding to the information adjustment manner; and

if yes, performing the step of obtaining attribute information corresponding to the historical advertisement information.

For example, a time period T0 (the time period may be a periodic time period) may be set for advertisement filtering, and a time period T1 (T1 may be before or after T0) may be set for advertisement weight adjustment and advertisement sequence adjustment.

If it is determined, according to the negative feedback reason, that the advertisement information adjustment manner is advertisement filtering, and the current system time is within T0, in this case, corresponding advertisement information may be removed from the advertisement queue.

If it is determined, according to the negative feedback reason, that the advertisement information adjustment manner is advertisement sequence adjustment or advertisement weight adjustment, and the current system time is within T1, in this case, sequence adjustment or weight adjustment processing may be performed on the advertisement queue.

Optionally, if the system time does not fall within the preset time period corresponding to the advertisement information adjustment manner, a target preset time period in which the system time falls may be determined. Then, the advertisement information queue is adjusted according to the advertisement information adjustment manner corresponding to the target preset time period. For example, when it is determined that the advertisement information adjustment manner is advertisement filtering, and if the current time does not fall within T0, but falls within T1, in this case, the advertisement queue may be adjusted according to a weight adjustment manner or a sequence adjustment manner corresponding to T1.

Optionally, in this embodiment, the advertisement traffic inventories, that is, the number of pieces of advertisement information in the advertisement information queue, needs to be further considered when sequence adjustment is performed on the advertisement information queue. When there are a few inventories, there is little significance to adjust the advertisement information queue. For example, when there are two pieces of advertisement in the queue, there is little significance to sort the two pieces of advertisement information, and basically, an advertisement presentation rate is not affected. Therefore, to save system resources, in this embodiment, the number of pieces of advertisement in the advertisement queue further needs to be determined, and adjustment is performed when the number satisfies a particular number, that is, after the step of “obtaining negative feedback information corresponding to the historical advertisement information” and before the step of “adjusting the advertisement information queue”, the embodiment method further includes:

obtaining the number of pieces of advertisement information in the information queue corresponding to the user identifier; and

determining whether the number is greater than a preset number; and

if yes, performing the step of adjusting, according to the negative feedback information, an advertisement information queue corresponding to the user identifier.

Step 105. Send corresponding advertisement information to a terminal according to the adjusted advertisement information queue.

Specifically, corresponding advertisement information is sent to the terminal sequentially from the head position (e.g., an information piece that ranks at the top of the queue) to the tail position (e.g., an information piece that ranks at the bottom) of the queue.

For example, referring to FIG. 1c, after weight adjustment is performed, advertisement 2, advertisement 3, advertisement 4, . . . , advertisement 1, . . . , and advertisement n may be sequentially sent to the terminal.

Optionally, in this embodiment, different adjustment policies may be used for different user groups. In this embodiment, user negative feedback behaviors may be analyzed to determine a group to which the user belongs, and then, different adjustment policies are used. In this way, the accuracy of advertisement advertising may be further improved. That is, after the step of “querying, historical advertisement information corresponding to the user identifier”, and before the step of “obtaining negative feedback information”, the embodiment method may further include:

obtaining behavior feature information of a current request user (the user corresponding to the user identifier) for a corresponding number of pieces of historical advertisement information;

determining whether the behavior feature information satisfies a preset condition; and

if not, performing the step of obtaining negative feedback information corresponding to the historical advertisement information.

The behavior feature information of the user for the corresponding number of pieces of historical advertisement information may present n pieces advertisement information and operation information of the user for the n pieces advertisement information to the user previously. For example, the behavior feature information may include a hit rate of the user (that is, a ratio of the number of pieces of advertisement information hit by the user to the total number of pieces of advertisement information), a negative feedback rate, and the like.

The negative feedback rate is a ratio of the number of pieces of advertisement information fed back by the user to the total number of pieces of advertisement information, or a ratio of the number of pieces of advertisement information that is negatively fed back by the user to the total number of pieces of advertisement information hit by the user. For example, when n pieces of advertisement information are presented, and the user performs negative feedback on m pieces of advertisement information, in this case, the negative feedback rate is m/n, where n is greater than or equal to m, and both m and n are positive integers. For another example, when n pieces of advertisement information are presented, and the user clicks k pieces of advertisement information, d negative feedbacks are provided for the k times of clicks, in this case, the negative feedback rate may be d/k, where both d and k are positive integers, and d is less than equal to k.

The preset condition may be set according to an actual requirement. For example, when the behavior feature information includes the hit rate and the negative feedback rate of the request user for the historical advertisement information, the preset condition may be that the hit rate is less than a first preset threshold, and the negative feedback rate is greater than a second preset threshold. That is, the step of “determining whether the behavior feature information satisfies a preset condition” may include:

determining that the behavior feature information satisfies the preset condition, when the hit rate is less than a first preset threshold, and the negative feedback rate is greater than a second preset threshold; or

determining that the behavior feature information does not satisfy the preset condition, when the hit rate is not less than a first preset threshold, or the negative feedback rate is not greater than a second preset threshold.

According to the embodiment method, when it is determined, based on the behavior feature information, that the request user is not a particular user group, the advertisement queue is adjusted, the flexibility of advertising of the advertisement information advertising is improved, and system terminals are reduced.

Optionally, when the behavior feature information satisfies the preset condition, the advertisement information corresponding to the user identifier is blocked. That is, all advertisement information in the advertisement information queue corresponding to the user identifier is blocked, and advertisement is no longer presented to the user.

For example, in a process of analyzing user negative feedback behaviors, it is found that some users never click advertisement, and each time the advertisement emerges, the users click negative feedbacks, showing a great resistance to the advertisement. The users are filtered out, and the filtering condition, that is, the preset condition is that: if advertisement is exposed for sufficient times to the user, if in the past n times of exposure, a hit rate of the user is lower than a hit rate threshold, and a negative feedback rate is greater than a negative feedback rate threshold, advertisement is no longer presented to the user.

Optionally, in this embodiment, different adjustment policies may be used for different advertisement features. Because negative feedback actions of the user reflect advertisement quality, from the perspective of advertisement, a negative feedback rate of a particular piece of advertisement may be calculated in a past period of time, and then, features of the advertisement are analyzed based on the negative feedback rate.

The negative feedback rate is different from the negative feedback rate of the foregoing request user for the corresponding number of historical advertisement information. The negative feedback rate is a negative feedback rate calculated from the perspective of advertisement. The negative feedback is specifically a ratio of the number of times that the historical advertisement information is negatively fed back (for example, closed, hidden, or reported) within a preset time period to the total number of times that the historical advertisement information is presented.

For example, when a negative feedback rate of a particular piece of advertisement is greater than a preset threshold, it may be considered that the user may be very resistant to advertisement of some sensitive industries, for example, dating advertisement. Because it is relatively difficult to estimate the marital status of the user, and when the user clicks a negative feedback, it most probably indicates that the user does not prefer such type of advertisement. Therefore, in this embodiment, advertisement of sensitive industries may be blocked, to improve the efficiency and the accuracy of advertising of the advertisement.

The negative feedback information may include a negative feedback rate corresponding to the historical advertisement information in the preset time period, and the step of “adjusting, according to the negative feedback information, an advertisement information queue corresponding to the user identifier” may include:

obtaining industry type information corresponding to the historical advertisement information, when the negative feedback rate is greater than a third preset threshold; and

blocking, according to the industry type information, corresponding information in the information queue corresponding to the user identifier.

For another example, when a negative feedback rate of a particular piece of advertisement is greater than a preset threshold, it may be considered that the advertisement may be sham advertisement, junk advertisement, and the like. In this case, advertisement that is in the queue and that is the same as the advertisement, or that belongs to a commodity the same as the advertisement does, or that belongs to an industry the same as the advertisement belongs, or that belongs to a category the same the advertisement does is sent to an audit system for auditing again. In this way, network resources and computer resources can be saved by blocking unwanted information for the user.

It may be learned from above that, in this embodiment of this application, the advertisement obtaining request sent by the terminal is received and used, the advertisement obtaining request carrying the user identifier, then, the historical advertisement information corresponding to the user identifier is queried according to the advertisement obtaining request, the negative feedback information that is for the historical advertisement information and that is of the user corresponding to the user identifier is obtained, the advertisement information queue corresponding to the user identifier is adjusted according to the negative feedback information, and corresponding advertisement information is sent to the terminal according to the adjusted advertisement information queue. In this solution, the to-be-sent advertisement information queue may be dynamically adjusted according to the negative feedback information that is for the historical advertisement information and that is of the user, and a presentation rate of advertisement information suitable for the user may be added. Therefore, according to the solution, the accuracy and the flexibility of advertising of the advertisement information advertising can be improved.

In addition, in this embodiment of this application, a negative feedback policy can be rapidly and scientifically set for different negative feedback capabilities in different scenarios according to traffic features, and properly adjusted according to an appraisal method, to ensure the experience level of user groups of different traffic. In addition, an advertisement exposure opportunity is reserved for more suitable advertisement, thereby improving the hit rate and the transformation effect of advertisers.

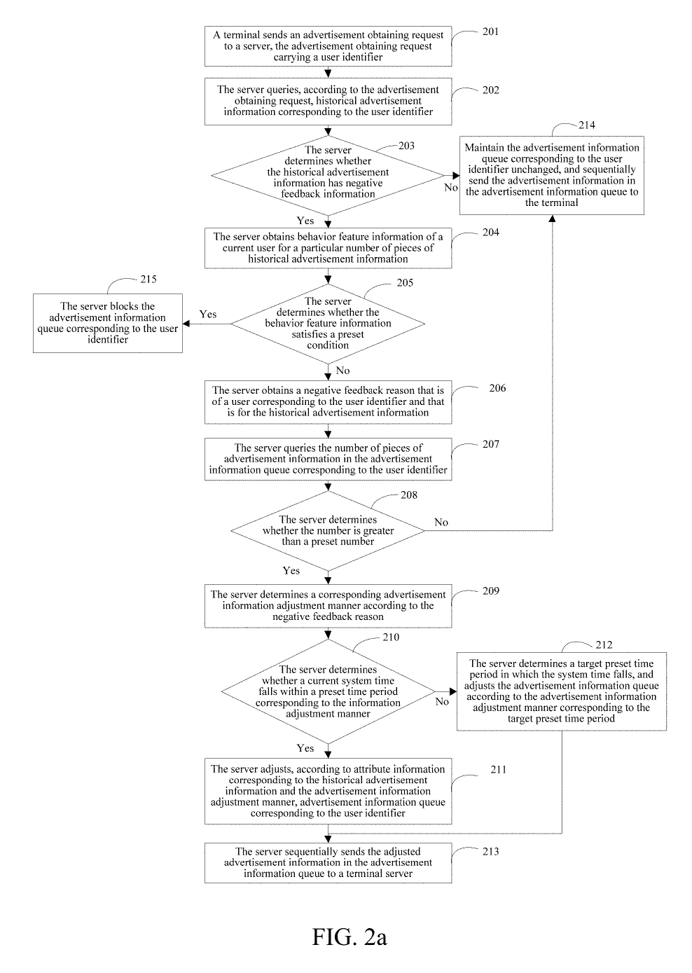

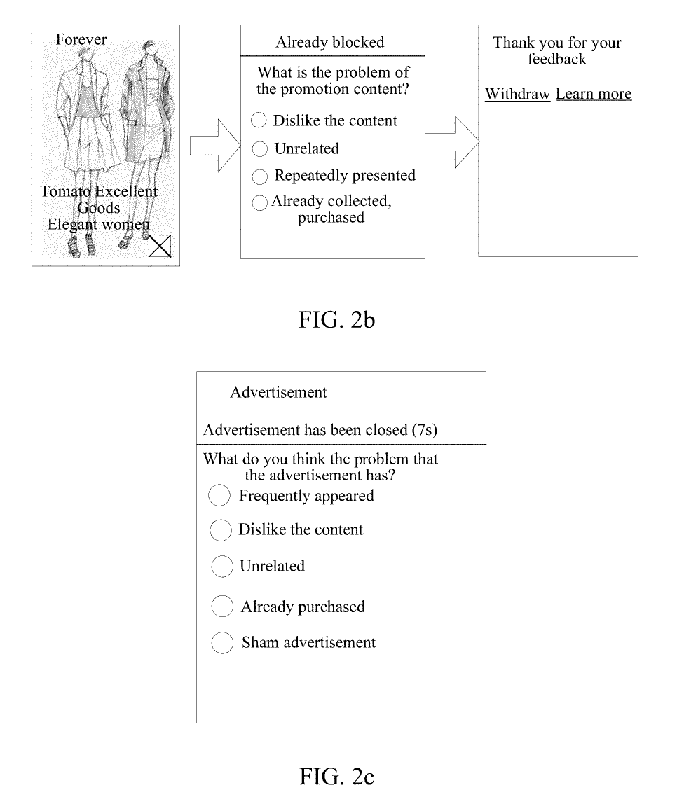

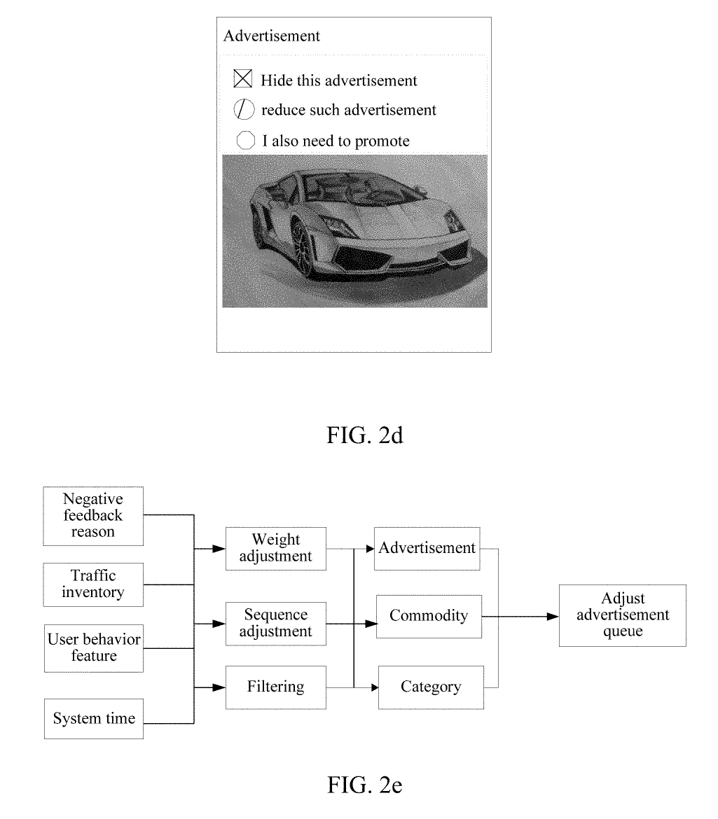

FIG. 2a is another flowchart of an information sending method according to an embodiment of this application. According to the method described in FIG. 1b, detailed description is made below by using examples.

In this embodiment, a description is provided still by using an example in which an advertisement information sending apparatus is specifically integrated on a server.

As shown in FIG. 2a, a specific procedure of an information sending method may be as follows:

Step 201. A terminal sends an advertisement obtaining request to a server, the advertisement obtaining request carrying a user identifier.

For example, after logging into the user identifier, the terminal may periodically send the advertisement obtaining request to the server.

Alternatively, the advertisement obtaining request may further be generated by triggering an advertisement obtaining interface corresponding to the terminal. There is a plurality of manners of obtaining the advertisement obtaining interface, for example, pressing a key.

The user identifier may be a social network account, an instant messaging account, and the like.

Step 202. The server queries, according to the advertisement obtaining request, historical advertisement information corresponding to the user identifier.

The historical advertisement information is advertisement information already sent to the user identifier previously.

For example, the server may query, according to the advertisement obtaining request, an advertisement exposure record corresponding to the user identifier, to query the historical advertisement information corresponding to the user identifier. The advertisement exposure record may include the advertisement information or an identifier of the advertisement information already sent to the user identifier previously.

Step 203. The server determines whether there is negative feedback information for the historical advertisement information, and if yes, perform step 204, or if not, perform step 214.

The negative feedback information is negative feedback information that is of a user corresponding to the user identifier and that is for the historical advertisement information.

The negative feedback information may include information fed back when the user corresponding to the user identifier closes, hides, or reports the historical advertisement information. For example, the negative feedback information is information fed back when the user corresponding to the user identifier closes the historical advertisement information by using a closing entrance of the historical advertisement information. The negative feedback information may include information about a negative feedback reason. The server may determine a hosting website or application of an information piece; based on the type of the hosting website or application, determine a negative feedback information reason selection interface corresponding to the type, such that the user terminal displays the corresponding negative feedback information reason selection interface. Three examples of negative feedback information reason selection interface at three types of the hosting website or application are illustrated below.

For example, FIG. 2b is a schematic diagram of an advertisement negative feedback according to an embodiment of this application. Referring to FIG. 2b, advertisement information is presented on a terminal side, and a closing entrance of the advertisement information may be provided. When a user clicks the closing entrance, the advertisement is blocked or closed, and a negative feedback reason selection interface is presented to the user. The interface includes a plurality of negative feedback reason options, then, the user may select a corresponding negative feedback reason from the interface, and then optionally a feedback success interface is presented, to prompt the user that feedback succeeds.

The negative feedback reason may be set according to an actual requirement, and negative feedback reasons set by social platforms may be different. For example, advertisement inventory compositions and user group compositions of different traffic are different, and therefore, settings of the negative feedback reason are also different.

For example, FIG. 2c is a schematic diagram of a negative feedback reason according to an embodiment of this application. Referring to FIG. 2c, in some social platforms, there are relatively few advertisement inventories in traffic, and each time the user refreshes a page at a position, the user refreshes new advertisement at the position. According to possible occurring experience problems of the traffic, the negative feedback reason may be set as: frequently appeared, dislike the content, unrelated, already purchased, sham advertisement, and the like.

For another example, FIG. 2d is another schematic diagram of a negative feedback reason according to an embodiment of this application. Referring to FIG. 2d, in some other social platforms, there are relatively abundant advertisement inventories. A traffic ticket user limits a limited number of times of advertisement exposure, and a few experience problems may occur. Therefore, the negative feedback reason may include: hiding such advertisement, reducing such advertisement, and the like.

Step 204. The server obtains behavior feature information of a current user for a corresponding number of pieces of historical advertisement information.

The behavior feature information of the user for the corresponding number of pieces of historical advertisement information may present n pieces advertisement information and operation information of the user for the n pieces advertisement information to the user previously. For example, the behavior feature information may include a hit rate of the user (that is, a ratio of the number of pieces of advertisement information hit by the user to the total number of pieces of advertisement information), a user negative feedback rate, and the like.

The user negative feedback rate is a ratio of the number of pieces of advertisement information fed back by the user to the total number of pieces of advertisement information, or a ratio of the number of pieces of advertisement information that is negatively fed back by the user to the total number of pieces of advertisement information hit by the user. For example, when n pieces of advertisement information are presented, and the user performs negative feedback on m pieces of advertisement information, in this case, the user negative feedback rate is m/n, where n is greater than or equal to m, and both m and n are positive integers. For another example, when n pieces of advertisement information are presented, and the user clicks k pieces of advertisement information, d negative feedbacks are provided for the k times of clicks, in this case, the user negative feedback rate may be d/k, where both d and k are positive integers, and d is less than equal to k.

Step 205. The server determines whether the behavior feature information satisfies a preset condition, and if not, performs step 206, or if yes, performs step 215.

Different adjustment policies may be used for different user groups. In this embodiment, user negative feedback behaviors may be analyzed to determine a group to which the user belongs, and then, different adjustment policies are used. In this way, the accuracy of advertisement advertising may be further improved.

When the behavior feature information does not satisfy the preset condition, the advertisement queue may be adjusted based on the negative feedback reason. When the preset condition is satisfied, it is considered that the current user belongs to a particular preset user group, and then adjustment may be performed by using other adjustment policies, for example, step 215 of blocking all advertisement information corresponding to the user identifier is performed.

For example, when the hit rate is less than a first preset threshold, and a user negative feedback rate is greater than a second preset threshold, it may be considered that the user does not click the advertisement, and each time the advertisement occurs, the user clicks a negative feedback, indicating a strong resistance to the advertisement. In this case, step 215 of blocking all advertisement information corresponding to the user identifier may be performed, and the advertisement is no longer presented to the user.

In this embodiment, the advertisement sending method in this application is described by using an example in which the negative feedback information is the negative feedback reason. It should be understood that in other embodiments, when the negative feedback information is an advertisement negative feedback rate corresponding to the historical advertisement information in a preset time period, the server may further determine whether the advertisement negative feedback rate is greater than a preset threshold. If the advertisement negative feedback rate is greater than the preset threshold, industry type information corresponding to the historical advertisement information is obtained, and corresponding advertisement information in the advertisement information queue that corresponds to the user identifier is blocked according to the industry type information. The queue is correspondingly adjusted from the perspective of a single piece of advertisement. If the advertisement negative feedback rate is not greater than the preset threshold, the server performs step 206, that is, performs adjustment based on the negative feedback reason.

For example, when an advertisement negative feedback rate of a particular piece of advertisement is greater than a preset threshold, it may be considered that the user may be very resistant to advertisement of some sensitive industries, for example, financial advertisement. When the user clicks a negative feedback, it most probably indicates that the user does not prefer such type of advertisement. Therefore, in this embodiment, advertisement of sensitive industries may be blocked, to improve the efficiency and the accuracy of advertising of the advertisement.

The step of determining, by the server, whether the advertisement negative feedback rate is greater than the preset threshold may be performed when the server determines that the behavior feature information satisfies the preset condition. For example, when determining that the hit rate is less than the first preset threshold, and the user negative feedback rate is greater than the second preset threshold, the server determines whether the advertisement negative feedback rate is greater than a third preset threshold, and if the advertisement negative feedback rate is not greater than the third preset threshold, step 206 is performed, or if the advertisement negative feedback rate is greater than the third preset threshold, corresponding advertisement information in the advertisement information queue that corresponds to the user identifier is directly blocked according to the industry type information of the historical advertisement information.

The advertisement negative feedback rate is different from the user negative feedback rate. The advertisement negative feedback rate is a negative feedback rate obtained from the perspective of advertisement, and the user negative feedback rate is a negative feedback rate obtained from the perspective of the user. The advertisement negative feedback may be a ratio of the number of times that the historical advertisement information is negatively fed back (for example, closed, hidden, or reported) within a preset time period to the total number of times that the historical advertisement information is presented.

Step 206. The server obtains a negative feedback reason that is of a user corresponding to the user identifier and that is for the historical advertisement information.

The negative feedback information may include information fed back when the user corresponding to the user identifier closes, hides, or reports the historical advertisement information. For example, the negative feedback information is information fed back when the user corresponding to the user identifier closes the historical advertisement information by using a closing entrance of the historical advertisement information. The negative feedback information may include information about a negative feedback reason.

Step 207. The server queries the number of pieces of advertisement information in the advertisement information queue corresponding to the user identifier.

Step 208. The server determines whether the number is greater than a preset number, and if yes, performs step 209, or if not, performs step 214.

When there are a few advertisement traffic inventories, that is, the number of pieces of advertisement information in the advertisement information queue, there is little significance to adjust the advertisement information queue. For example, when there are two pieces of advertisement in the queue, there is little significance to sort the two pieces of advertisement information, and basically, an advertisement presentation rate is not affected. Therefore, to save system resources, the advertisement number further needs to be determined, to determine whether the queue needs to be adjusted.

Step 209. The server determines a corresponding advertisement information adjustment manner according to the negative feedback reason.

There is a plurality of advertisement information adjustment manners, which may be specifically set according to an actual requirement. For example, the advertisement information adjustment manner may include: adjusting (for example, sorting) the positions of the advertisement information in the advertisement information queue, filtering (removing or deleting) the advertisement information in the queue, adjusting content of the advertisement information in the queue, adjusting the size of the advertisement information in the queue, adjusting the category of the advertisement information in the queue, and the like.

Adjustment of the positions of the advertisement information in the queue may be specifically performed in a weight adjustment manner or a sequence adjustment manner. For details, refer to the descriptions of the embodiment shown in FIG. 1b.

In this embodiment, the server may determine a reason type to which the negative feedback reason belongs, obtain a preset advertisement information adjustment manner corresponding to the reason type, and use the preset advertisement information adjustment manner as a current advertisement information adjustment manner.

Specifically, the negative feedback reason of the advertisement may be classified to obtain a plurality of reason types. For example, based on emotion or perception to the advertisement, the negative feedback reason may be classified into an advertisement type fed up by a user and an advertisement type not fed up by a user, or the negative feedback reason is classified into an advertisement hidden type and an advertisement deleted type.

For example, when the negative feedback reason is “dislike the content”, it may be determined that the reason type to which the reason belongs is the advertisement type fed up by the user. In this case, the advertisement information adjustment manner corresponding to the advertisement type fed up by the user may be obtained to performing filtering or deleting on the advertisement queue. For another example, when the negative feedback reason is hiding the advertisement, it may be determined that the reason type to which the reason belongs is the advertisement hidden type, and in this case, the obtained advertisement information adjustment manner corresponding to the reason type may be that: re-sorting the advertisement in the advertisement queue.

Step 210. The server determines whether a current system time falls within a preset time period corresponding to the advertisement information adjustment manner, and if yes, performs step 211, or if not, performs step 212.

To avoid a reduction in the accuracy and the flexibility of advertising of the advertisement information due to that some advertisement information that is negatively fed back, or advertisement information related to the negative feedback advertisement is not presented within a long time, or a presentation rate is relatively low within a long time, in this embodiment, an adjustment time period may be set for each advertisement information adjustment manner, and the queue is adjusted only in the corresponding adjustment time period. That is, different processing phases may be designed in a time dimension.

For example, a time period T0 (the time period may be a periodic time period) may be set for advertisement filtering, and a time period T1 (T1 may be before or after T0) may be set for advertisement weight adjustment and advertisement sequence adjustment. If it is determined, according to the negative feedback reason, that the advertisement information adjustment manner is advertisement filtering, and the current system time is within T0, in this case, corresponding advertisement information may be removed from the advertisement queue.

Step 211. The server adjusts, according to attribute information corresponding to the historical advertisement information and the advertisement information adjustment manner, advertisement information queue corresponding to the user identifier. Then, step 213 is performed.

The attribute information of the advertisement information may be obtained by classifying or defining the advertisement information from different perspectives.

For example, the attribute information of the advertisement information may include a commodity attribute of the advertisement information and an advertisement attribute of the advertisement information. The advertisement attribute may include information such as an identifier of the advertisement information, advertisement category information corresponding to the advertisement information, industry information corresponding to the advertisement information (such as dating-type advertisement, cloth advertisement, and financial advertisement). The commodity attribute of the advertisement information may include commodity information (information such as a commodity name, a price, and a commodity manufacturer) of a commodity to which the advertisement information belongs. In an actual application, the advertisement attribute and the commodity attribute may overlap. For example, the industry information of the commodity to which the advertisement belongs may be commodity information or advertisement industry information.

In an actual application, one commodity may correspond to a plurality of pieces of advertisement, and one piece of advertisement only belongs to one commodity.

In this embodiment, the advertisement queue may be adjusted from dimensions such as the advertisement identifier, the advertisement category, and the advertisement commodity. For example, when the attribute information includes an advertisement identifier (ID) of the historical advertisement information, weight adjustment and sequence adjustment may be performed on advertisement information that has an ID the same as that of the historical advertisement information in the advertisement information queue.

Step 212. The server determines a target preset time period in which the system time falls, and adjusts the advertisement information queue according to the advertisement information adjustment manner corresponding to the target preset time period. Then, step 213 is performed.

For example, when it is determined that the advertisement information adjustment manner is advertisement weight adjustment, and if the current time does not fall within T1, but falls within T0, in this case, the advertisement information in the advertisement queue may be filtered according to an advertisement filtering adjustment manner corresponding to T0.

Step 213. The server sequentially sends the adjusted advertisement information in the advertisement information queue to the terminal.

Step 214. The server maintains the advertisement information queue corresponding to the user identifier unchanged, and sequentially sends the advertisement information in the advertisement information queue to the terminal.

Step 215. The server blocks the advertisement information queue corresponding to the user identifier.

It may be learned from above that, in this embodiment of this application, the advertisement obtaining request sent by the terminal is received and used, the advertisement obtaining request carrying the user identifier, then, the historical advertisement information corresponding to the user identifier is queried according to the advertisement obtaining request, the negative feedback information that is for the historical advertisement information and that is of the user corresponding to the user identifier is obtained, the advertisement information queue corresponding to the user identifier is adjusted according to the negative feedback information, and corresponding advertisement information is sent to the terminal according to the adjusted advertisement information queue. In this solution, the to-be-sent advertisement information queue may be dynamically adjusted according to the negative feedback information that is for the historical advertisement information and that is of the user, and a presentation rate of advertisement information suitable for the user may be added. Therefore, according to the solution, the accuracy and the flexibility of advertising of the advertisement information advertising can be improved.

Specifically, referring to FIG. 2e, FIG. 2e is another schematic diagram of adjustment of an information queue according to an embodiment of this application. According to the embodiment method, the negative feedback reason, the advertisement traffic inventory, the user behavior feature, and the current system time are comprehensively considered to determine an adjustment manner of the advertisement queue. For example, the advertisement adjustment is performed by selecting one of manners such as weight adjustment, sequence adjustment, and filtering.

In this way, in this embodiment method of this application, a negative feedback policy can be rapidly and scientifically set for different negative feedback capabilities of different scenarios according to traffic features, and properly adjusted according to an appraisal method, to ensure the experience level of user groups of different traffic. In addition, an advertisement exposure opportunity is reserved for more suitable advertisement, thereby improving the hit rate and the transformation effect of advertisers.

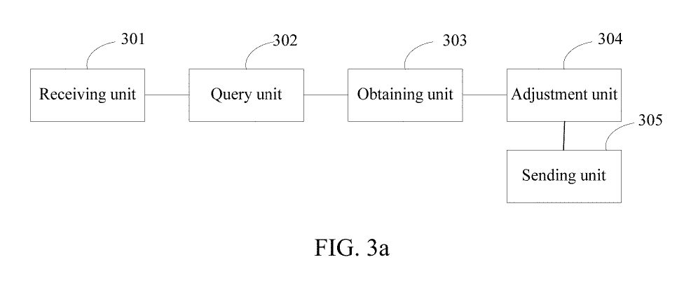

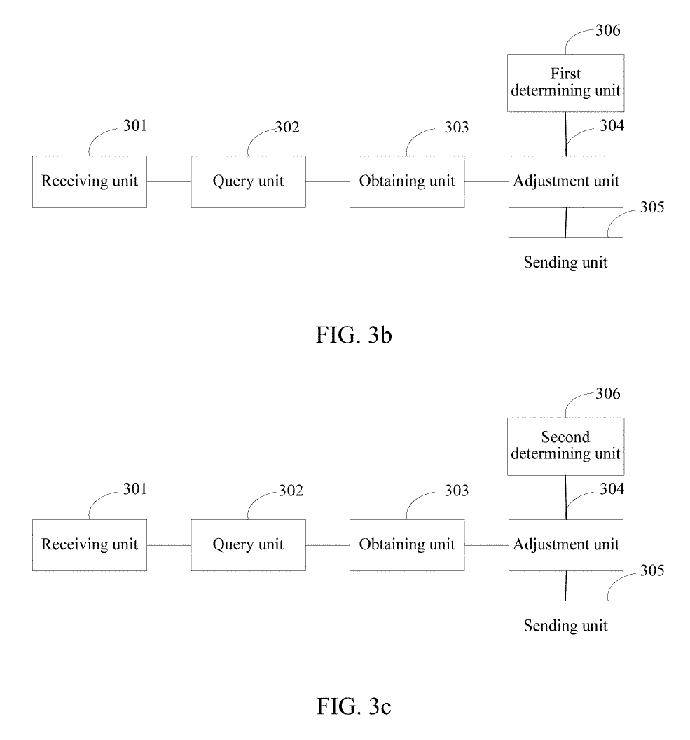

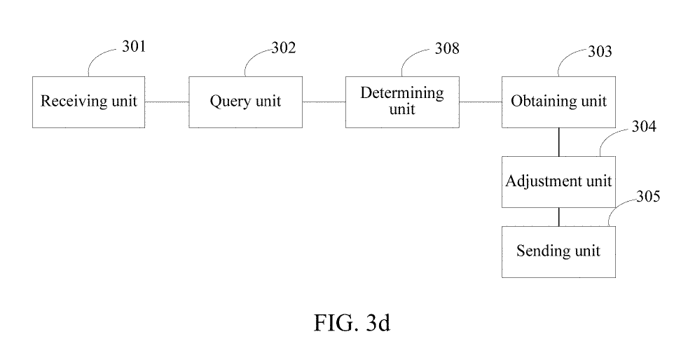

To better implement the foregoing method, an embodiment of this application further provides an advertisement information sending apparatus. FIG. 3a is a schematic structural diagram of the information sending apparatus according to an embodiment of this application. As shown in FIG. 3a, the advertisement information sending apparatus includes a receiving unit 301, a query unit 302, an obtaining unit 303, an adjustment unit 304, and a sending unit 305 as follows:

(1) A Receiving Unit 301;

The receiving unit 301 is configured to receive an advertisement obtaining request sent by a terminal, the advertisement obtaining request carrying a user identifier.

(2) A Query Unit 302;

The query unit 302 is configured to query, according to the advertisement obtaining request, historical advertisement information corresponding to the user identifier.

The historical advertisement information is advertisement information already sent to the user identifier previously.

For example, the query unit 302 may obtain, according to the advertisement obtaining request, a historical advertisement recording file corresponding to the user identifier may be obtained, and then, query the historical advertisement recording file for the historical advertisement information.

(3) An Obtaining Unit 303;

The obtaining unit 303 is configured to obtain negative feedback information that is of a user corresponding to the user identifier and that is for the historical advertisement information.

The negative feedback information may include information fed back when the user corresponding to the user identifier closes, hides, or reports the historical advertisement information. For example, the negative feedback information is information fed back when the user corresponding to the user identifier closes the historical advertisement information by using a closing entrance of the historical advertisement information. The negative feedback information may include information about a negative feedback reason.

The negative feedback reason may be set according to an actual requirement, and negative feedback reasons set by social platforms may be different. For example, advertisement inventory compositions and user group compositions of different traffic are different, and therefore, settings of the negative feedback reason are also different.

For example, in some embodiments, the negative feedback reason may include: frequently appeared, dislike the content, unrelated, already purchased, sham advertisement, and the like. In some other embodiments, the negative feedback reason may include: hiding this advertisement, reducing such advertisement, and the like.

(4) An Adjustment Unit 304;

The adjustment unit 304 is configured to adjust, according to the negative feedback information, an advertisement information queue corresponding to the user identifier.

The negative feedback information may include the negative feedback reason, and in this case, the adjustment unit 304 may include:

a determining subunit (not shown in FIG. 3a), configured to determine a corresponding information adjustment manner according to the negative feedback reason;

an attribute obtaining subunit (not shown in FIG. 3a), configured to obtain attribute information corresponding to the historical advertisement information; and

an adjustment subunit (not shown in FIG. 3a), configured to adjust, according to the advertisement information adjustment manner and the attribute information, the advertisement information queue corresponding to the user identifier.

For example, the determining subunit may be configured to: determine a reason type to which the negative feedback reason belongs, and obtain an advertisement information adjustment manner corresponding to the reason type. Alternatively, the determining subunit is configured to: match the negative feedback reason with a sample reason in a preset reason set, and obtain an advertisement information adjustment manner corresponding to a matching sample reason.

For another example, the determining subunit is configured to determine, based on the negative feedback reason, the corresponding advertisement information adjustment manner in various candidate advertisement information adjustment manners.

The attribute information of the advertisement information may be obtained by classifying or defining the advertisement information from different perspectives. For example, the attribute information of the advertisement information may include at least one of: an identifier of the advertisement information, advertisement category information corresponding to the advertisement information, commodity information of commodities to which the advertisement information belongs (information such as commodity names, prices, and commodity manufacturers), and industry information corresponding to the advertisement information (such as dating-type advertisement, cloth advertisement, and financial advertisement). For example, the adjustment subunit may be specifically configured to:

determining, according to the attribute information, corresponding target advertisement information in the advertisement information queue corresponding to the user identifier; and

adjusting a position of the target advertisement information in the advertisement information queue.

For another example, the adjustment subunit may be specifically configured to:

determining, according to the attribute information, corresponding target advertisement information in the advertisement information queue corresponding to the user identifier; and

removing the target advertisement information from the advertisement information queue.

Optionally, the negative feedback information includes a negative feedback rate corresponding to the historical advertisement information in the preset time period; and in this case, the adjustment unit 304 may include:

an industry information obtaining subunit, configured to: obtain industry type information corresponding to the historical information, when the negative feedback rate is greater than a third preset threshold; and

a blocking subunit, configured to block, according to the industry type information, corresponding information in the information queue corresponding to the user identifier.

(5) A Sending Unit 305;

The sending unit 305 is configured to send corresponding advertisement information to a terminal according to the adjusted advertisement information queue.

Optionally, referring to FIG. 3b, FIG. 3b is another schematic structural diagram of an information sending apparatus according to an embodiment of this application. The advertisement information sending apparatus may further include a first determining unit 306, configured to: obtain a current system time, and determine whether the system time falls within a preset time period corresponding to the advertisement information adjustment manner, after the determining subunit determines the corresponding advertisement information adjustment manner according to the negative feedback reason, and before the attribute obtaining subunit obtains the attribute information.

The attribute obtaining subunit is specifically configured to obtain the attribute information corresponding to the historical advertisement information when the first determining unit 306 determines that the system time falls within the preset time period.

Optionally, referring to FIG. 3c, FIG. 3c is another schematic structural diagram of an information sending apparatus according to an embodiment of this application. The advertisement information sending apparatus may further include a second determining unit 307, configured to: after the obtaining unit 303 obtains the negative feedback information and before the adjustment unit 304 adjusts the information queue, obtain the number of pieces of advertisement information in the advertisement information queue corresponding to the user identifier; and determine whether the number is greater than a preset number.

The adjustment unit 304 is configured to adjust, according to the negative feedback information, an advertisement information queue corresponding to the user identifier, if the second determining unit 307 determines that the number is greater than the preset number.

Optionally, referring to FIG. 3d, FIG. 3d is another schematic structural diagram of an information sending apparatus according to an embodiment of this application. The advertisement information sending apparatus may further include a determining unit 308, configured to: after the query unit 302 queries the historical advertisement information corresponding to the user identifier, and before the obtaining unit 303 obtains the negative feedback information corresponding to the historical advertisement information, obtain behavior feature information of a current request user for a particular number of pieces of historical advertisement information; and determine whether the behavior feature information satisfies a preset condition.

The obtaining unit 303 is configured to: when the determining unit 308 determines that the behavior feature information does not satisfy the preset condition, obtain the negative feedback information that is for the advertisement historical information and that is of the user corresponding to the user identifier.

The adjustment unit 304 may further be configured to block the advertisement information corresponding to the user identifier when the behavior feature information satisfies the preset condition.

The behavior feature information includes: a hit rate and a negative feedback rate of the request user for the historical advertisement information.

The determining unit 308 may be specifically configured to:

determining that the behavior feature information satisfies the preset condition, when the hit rate is less than a first preset threshold, or the negative feedback rate is greater than a second preset threshold; or

determining that the behavior feature information does not satisfy the preset condition, when the hit rate is not less than a first preset threshold, or the negative feedback rate is not greater than a second preset threshold.

During specific implementation, the foregoing units may be implemented as independent entities, or may be combined arbitrarily, or may be implemented as a same entity or several entities. For specific implementation of the foregoing units, refer to the foregoing method embodiments. Details are not described herein again.

The advertisement information sending apparatus may be specifically integrated into a network device such as a server, and the server may be an independent entity, or may include a plurality of entities.

It may be learned from above that according to the advertisement information sending apparatus in this embodiment of this application, the receiving unit 301 receives the advertisement obtaining request sent by the terminal, the advertisement obtaining request carrying the user identifier, then, the query unit 302 queries, according to the advertisement obtaining request, the historical advertisement information corresponding to the user identifier, the obtaining unit 303 obtains the negative feedback information that is for the historical advertisement information and that is of the user corresponding to the user identifier, the adjustment unit 304 adjusts, according to the negative feedback information, the advertisement information queue corresponding to the user identifier, and the sending unit 305 sends corresponding advertisement information to the terminal according to the adjusted advertisement information queue. According to the solution, a to-be-sent advertisement information queue may be dynamically adjusted according to the negative feedback information of the user for the historical advertisement information, a presentation rate of advertisement information suitable for the user may be increased. Therefore, according to the solution, the accuracy and the flexibility of advertising of the advertisement information can be improved.

In addition, in this embodiment of this application, a negative feedback policy can be rapidly and scientifically set different negative feedback capabilities of different scenarios according to traffic features, and properly adjusted according to an appraisal method, to ensure the experience level of user groups of different traffic. In addition, an advertisement exposure opportunity is reserved for more suitable advertisement, thereby improving the hit rate and the transformation effect of advertisers.

In addition, an embodiment of the present disclosure further provides an advertisement information sending system, which may include any advertisement information sending apparatus according to the embodiments of the present disclosure. For example, details may be as follows:

The advertisement information sending apparatus is configured to: receive advertisement obtaining request sent by a terminal, the advertisement obtaining request carrying a user identifier, then query, according to the advertisement obtaining request, historical advertisement information corresponding to the user identifier, obtain negative feedback information that is of a user corresponding to the user identifier and that is for the historical advertisement information, adjust, according to the negative feedback information, an advertisement information queue corresponding to the user identifier, and send corresponding advertisement information to the terminal according to the adjusted advertisement information queue.

The advertisement information sending apparatus may be specifically integrated into a network device such as a server, and details are not described herein again.

For a specific implementation of each of the foregoing devices, refer to the foregoing embodiments, and details are not described herein again.

In addition, the advertisement information sending system may further include other devices, for example, a terminal, a gateway, or other servers. Details are not described herein again.

The advertisement information sending system may include any advertisement information sending apparatus provided in the embodiments of the present disclosure, and therefore, can achieve the beneficial effects that can be achieved by any advertisement information sending apparatus provided in the embodiments of the present disclosure. For details, refer to the foregoing embodiments. Details are not described herein again.

The information sending method, the apparatus, and the system in the embodiments of this application are described in detail above by using an example in which information is advertisement information, and an information obtaining request is an advertisement obtaining request. For a case in which information is multimedia information, product information, resource information, and particular presentation information, refer to the descriptions of the embodiments in a case in which information is the advertisement information. It is desirable when corresponding parts are equivalently replaced.

A person of ordinary skill in the art may understand that all or some of the steps of the methods in the foregoing embodiments may be implemented by a program instructing relevant hardware. The program may be stored in a computer readable storage medium. The storage medium may include: a read-only memory (ROM), a random access memory (RAM), a magnetic disk, an optical disc, or the like.

The information sending method, the apparatus, and the system provided in the embodiments of the present disclosure are described above in detail. Although the principles and implementations of the present disclosure are described by using specific examples in this specification, the descriptions of the foregoing embodiments are merely intended to help understand the method and the core idea of the method of the present disclosure. Meanwhile, a person skilled in the art may make modifications to the specific implementations and application range according to the idea of the present disclosure. In conclusion, the content of this specification should not be construed as a limitation to the present disclosure.

What is claimed is:

1. An information sending method, comprising:
receiving, by a server, an information obtaining request sent by a terminal, the information obtaining request carrying a user identifier;
querying, by the server according to the information obtaining request, historical information corresponding to the user identifier;
obtaining, by the server, negative feedback information corresponding to the user identifier and associated with the historical information, the negative feedback information comprising a negative feedback reason;
determining, by the server, an information adjustment manner according to the negative feedback reason in the negative feedback information;
adjusting, according to the information adjustment manner, an information queue corresponding to the user identifier; and
sending, by the server, corresponding information to the terminal according to the adjusted information queue.

2. The information sending method according to claim 1, wherein:
the method further comprises: obtaining, by the server, attribute information corresponding to the historical information; and
the adjusting, according to the information adjustment manner, the information queue corresponding to the user identifier comprises: adjusting, according to the information adjustment manner and the attribute information, the information queue corresponding to the user identifier.

3. The information sending method according to claim 1, wherein the determining, by the server, the information adjustment manner according to the negative feedback reason comprises:
determining, by the server, a reason type to which the negative feedback reason belongs; and
obtaining, by the server, the information adjustment manner corresponding to the reason type.

4. The information sending method according to claim 2, wherein:
the information adjustment manner comprises: adjusting positions of information pieces in the information queue; and
the adjusting, by the server according to the information adjustment manner and the attribute information, the information queue corresponding to the user identifier comprises:
determining, by the server, a target information piece in the information queue corresponding to the user identifier according to the attribute information; and
adjusting, by the server, a position of the target information piece in the information queue.

5. The information sending method according to claim 4, wherein the adjusting, by the server, the position of the target information piece in the information queue comprises:
configuring, by the server, a sorting parameter value corresponding to the target information piece; and
sorting, by the server, the positions of the information pieces in the information queue according to sorting parameter values corresponding to the information pieces in the information queue.

6. The information sending method according to claim 2, wherein:
the information adjustment manner comprises: deleting the information from the information queue; and
the adjusting, by the server according to the information adjustment manner and the attribute information, the information queue corresponding to the user identifier comprises:
determining, by the server, a target information piece in the information queue corresponding to the user identifier according to the attribute information; and
deleting, by the server, the target information piece from the information queue.

7. The information sending method according to claim 2, wherein after the determining the information adjustment manner according to the negative feedback reason, and before the obtaining the attribute information, the method further comprises:
obtaining, by the server, a current system time;
determining, by the server, whether the system time falls within a preset time period corresponding to the information adjustment manner; and
in response to determining that the system time falls within the preset time period corresponding to the information adjustment manner, performing the step of obtaining, by the server, the attribute information corresponding to the historical information.

8. The information sending method according to claim 1, wherein before the adjusting the information queue, the method further comprises:
obtaining, by the server, a number of pieces of information in the information queue corresponding to the user identifier; and
determining, by the server, whether the number is greater than a preset number; and
in response to determining that the number is greater than the preset number, performing the step of determining, by the server, the information adjustment manner according to the negative feedback reason in the negative feedback information.

9. The information sending method according to claim 1, wherein after the querying, the historical information corresponding to the user identifier, and before the obtaining the negative feedback information, the method further comprises:
obtaining, by the server, behavior feature information corresponding to the user identifier and associated with a number of pieces of the historical information;
determining, by the server, whether the behavior feature information satisfies a preset condition; and
in response to determining that the behavior feature information does not satisfy the preset condition, performing the step of obtaining, by the server, the negative feedback information corresponding to the user identifier and associated with the historical information.

10. The information sending method according to claim 9, further comprising:
blocking, by the server, the information corresponding to the user identifier, in response to determining that the behavior feature information satisfies the preset condition.

11. The information sending method according to claim 10, wherein the behavior feature information comprises: a hit rate and a negative feedback rate corresponding to the user identifier and associated with the pieces of the historical information; and
the determining, by the server, whether the behavior feature information satisfies the preset condition comprises:
determining, by the server, that the behavior feature information satisfies the preset condition, when the hit rate is less than a first preset threshold, and the negative feedback rate is greater than a second preset threshold; or
determining, by the server, that the behavior feature information does not satisfy the preset condition, when the hit rate is not less than the first preset threshold, or the negative feedback rate is not greater than the second preset threshold.

12. The information sending method according to claim 1, wherein:
the negative feedback information further comprises a negative feedback rate corresponding to a piece of the historical information in a preset time period; and
the method further comprises:
obtaining, by the server, industry type information corresponding to the piece of the historical information, when the negative feedback rate is greater than a third preset threshold; and
blocking, by the server according to the industry type information, one or more information pieces in the information queue corresponding to the user identifier.

13. An information sending apparatus, comprising a processor and a memory connected to the processor, the memory storing an instruction capable of being executed by the processor, and the processor is configured to:
receive an information obtaining request sent by a terminal, the information obtaining request carrying a user identifier;
query, according to the information obtaining request, historical information corresponding to the user identifier;
obtain negative feedback information corresponding to the user identifier and associated with the historical information, the negative feedback information comprising a negative feedback reason;
determine an information adjustment manner according to the negative feedback reason in the negative feedback information;
adjust, according to the information adjustment manner, an information queue corresponding to the user identifier; and
send corresponding information to the terminal according to the adjusted information queue.

14. The information sending apparatus according to claim 13, wherein the processor is further configured to:
determine the information adjustment manner according to the negative feedback reason;
obtain attribute information corresponding to the historical information; and
adjust, according to the information adjustment manner and the attribute information, the information queue corresponding to the user identifier.

15. The information sending apparatus according to claim 14, wherein:
the information adjustment manner comprises: adjusting positions of information in the information queue; and
the processor is further configured to:
determine a target information piece in the information queue corresponding to the user identifier according to the attribute information; and
adjust a position of the target information piece in the information queue.

16. The information sending apparatus according to claim 14, wherein the processor is further configured to:
obtain a current system time;
before the information adjustment manner is determined and after the attribute information is obtained, determine whether the system time falls within a preset time period corresponding to the information adjustment manner; and
obtain the attribute information corresponding to the historical information in response to determining that the system time falls within the preset time period.

17. The information sending apparatus according to claim 13, wherein the processor is further configured to:
before the information queue is adjusted, obtain a number of pieces of information in the information queue corresponding to the user identifier;
determine whether the number is greater than a preset number; and
when the number is greater than the preset number, determine the information adjustment manner according to the negative feedback reason in the negative feedback information.

18. The information sending apparatus according to claim 13, wherein the processor is further configured to
after the historical information corresponding to the user identifier is queried, and before the negative feedback information is obtained, obtain behavior feature information of corresponding to the user identifier and for a number of pieces of the historical information;
determine whether the behavior feature information satisfies a preset condition; and
when the behavior feature information does not satisfy the preset condition, obtain the negative feedback information corresponding to the user identifier and associated with the historical information.

19. The information sending apparatus according to claim 13, wherein the negative feedback information further comprises a negative feedback rate corresponding to a piece of the historical information in a preset time period; and
the processor is further configured to:
obtain industry type information corresponding to the piece of the historical information, when the negative feedback rate is greater than a third preset threshold; and
block, according to the industry type information, one or more information pieces in the information queue corresponding to the user identifier.

20. A non-transitory storage medium, storing a computer program that, when being executed by a processor, cause the processor to perform:
receiving an information obtaining request sent by a terminal, the information obtaining request carrying a user identifier;
querying, according to the information obtaining request, historical information corresponding to the user identifier;
obtaining negative feedback information corresponding to the user identifier and associated with the historical information, the negative feedback information comprising a negative feedback reason;
determining, an information adjustment manner according to the negative feedback reason in the negative feedback information;
adjusting, according to the information adjustment manner, an information queue corresponding to the user identifier; and
sending corresponding information to the terminal according to the adjusted information queue.
